(19) United States
(12) Patent Application Publication
(10) Pub. No.: US 2010/0009011 A1
(43) Pub. Date: Jan. 14, 2010

(54) POLYURETHANE FOAMS HAVING A DISINFECTING AND/OR BLEACHING EFFECT

(75) Inventors: Andreas Arlt, Esslingen (DE); Michael Klemm, Lemfoerde (DE); Bernhard Fussnegger, Kirrweiler (DE); Rudi Mortelmans, Steendorp (BE); Peter Spanhove, Wetteren (BE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/373,964

(22) PCT Filed: Jun. 18, 2007
(86) PCT No.: PCT/EP07/56033

§ 371 Date: Jan. 15, 2009

(30) Foreign Application Priority Data
Jul. 21, 2006 (EP) 06117624.4

(51) Int. Cl. A01N 59/00; A01N 25/16; A01N 59/16; A01P 1/00

(52) U.S. Cl. 424/616; 514/772.5; 252/186.1; 252/186.43; 424/618; 252/186.25

(57) ABSTRACT

The invention relates to polyurethane foams comprising polymers of heterocyclic N-vinyl monomers (i) and a disinfectant or bleaching agent (ii).

The invention relates to polyurethane foams, for example flexible, semirigid or rigid foams, preferably open-cell foams, preferably hydrophilic foams, comprising polymers of heterocyclic N-vinyl monomers (i) and a disinfectant and/or bleaching agent (ii).

The production of polyurethane foams, also referred to below as PUR foams, by reacting polyisocyanates with compounds having at least two reactive hydrogen atoms has been known for a long time and has been widely described.

The use of hydrogen peroxide for disinfection and bleaching is likewise known. It is equally known that hydrogen peroxide decomposes upon prolonged storage. To stabilize the hydrogen peroxide, it is complexed e.g. in WO 97/20867 with polymers of heterocyclic N-vinyl monomers. The pulverulent complexes produced in the process can be used as disinfecting and/or bleaching agent in highly diverse applications.

The use of compounds comprising silver, copper and zinc, such as, for example, silver, copper and zinc salts of mineral acids or inorganic silver, copper and zinc complexes with e.g. zeolites or zirconium phosphates, is likewise known for disinfection and sterilization.

The use of polymers which comprise antimicrobial or disinfectant agents is also known. Thus, for example, WO 84/01102 and U.S. Pat. No. 4,769,013 describe polyurethanes which comprise covalently bonded polyvinylpyrrolidone. The modified polyurethanes produced in this way are brought, in a second step, into contact with an antimicrobial or disinfectant agent such as, for example, iodine, iodide ions, hexachlorophene, the disinfectant agent being fixed by the polyvinylpyrrolidone.

A disadvantage of these methods is that the polyvinylpyrrolidone has to be fixed to the polyurethane in a costly process either by prepolymerization or by impregnation and subsequent crosslinking.

The use of silver-containing polymers as disinfectant wound coverings is known. Thus, WO 2000/009173 describes the production of hydrophilic polymers which comprise silver complexed to an alkylamine or an amino alcohol. Hydrophilic polymers comprising silver in ionic and complexed form besides other disinfectants are also described in US 2005/196431.

It was an object of the present invention to develop polymers which comprise complexed disinfectant and/or bleaching agents which are able to release these again in a time-controlled manner to the medium surrounding them and thus to develop their disinfectant and/or bleaching effect. Furthermore, the polymers should protect the disinfectant and/or bleaching agent present against gradual decomposition prior to its use.

The object of the present invention was achieved by polyurethane foams which comprise a complex of (i) and the disinfectant and/or bleaching agent (ii).

Accordingly, the invention provides polyurethane foams comprising polymers of heterocyclic N-vinyl monomers (i) and a disinfectant and/or bleaching agent (ii).

The invention further provides a method of producing polyurethane foams comprising crosslinked polymers of heterocyclic N-vinyl monomers (i) and a disinfectant and/or bleaching agent (ii), comprising the steps
a) reaction of polyisocyanates with compounds having at least two hydrogen atoms reactive with isocyanate groups in the presence of polymers of heterocyclic N-vinyl monomers (i),
b) impregnation of the foam with a disinfectant bleaching agent (ii).

The invention further provides the use of the foams according to the invention in the field of disinfection, hygiene and bleaching.

The crosslinked polymers of heterocyclic N-vinyl monomers (i), which are usually insoluble, are preferably chosen from the group comprising vinylpyrrolidone homopolymers, polyvinylpyrrolidone, modified polyvinylpyrrolidine, copolymers of vinylpyrrolidone with vinylimidazole, copolymers of vinylpyrrolidone with vinyl acetate, copolymers of vinylpyrrolidone with vinylformamide.

For the purposes of the invention, insoluble means that the polymers are soluble neither in water nor in customary organic solvents, with a fraction of soluble fractions of <2% by weight. The polymer component (i) can here be used in various particle sizes from 3-500 μm, i.e. also in micronized form. (i) is preferably insoluble polyvinylpyrrolidone (PVP) and/or insoluble copolymers of vinylpyrrolidone and vinylimidazole. Such products are sold commercially, for example, by BASF Aktiengesellschaft under the trade names Kollidon®, Luvicross®, Luvitec® , Luvicap® and Divergan®.

The complex of (i) and (ii) can also be added to the starting components of the polyurethane formulation in preprepared form. Since the preprepared complex of (i) and (ii) can decompose during the production of the polyurethane foams on account of the reaction conditions, the polymers of heterocyclic N-vinyl monomers (i) are preferably incorporated by polymerization in a first step during the production of the polyurethane foam, and in a second step the foam comprising the polymers of heterocyclic N-vinyl monomers (i) produced in this way is brought into contact with the disinfectant and/or bleaching agent (ii), with a complex of (i) and (ii) forming on the foam.

In this embodiment, the crosslinked and thus insoluble vinylpyrrolidone homopolymers, and the crosslinked and thus insoluble copolymers of vinylpyrrolidone with vinylimidazole can be added as powders preferably to the polyol component in dispersed form. During the polyurethane reaction, they behave inertly and are incorporated into the foam matrix.

In a next step, the foams produced in this way can be impregnated with the disinfectant and/or bleaching agent (ii) or a solution of (ii). After impregnating the foam with the disinfectant and/or bleaching agent (ii) or a solution of (ii) in a suitable solvent, the foam is thermally treated at temperatures between 0-80° C., preferably 20-60° C. Suitable solvents are protic solvents, for example water, ethanol, isopropanol or methyl ethyl ketone. The solvent can be removed from the foams impregnated with disinfectant and/or bleaching agent (ii) by drying, possibly with the application of reduced pressure. As a result of impregnating the foam comprising polymer (i) with the disinfectant and/or bleaching agent (ii), immediate complexation of the disinfectant and/or bleaching agent (ii) with the polymer (i) takes place. Complexation does take place at room temperature, but can be accelerated by a thermal treatment. The reaction time is usually governed by the size of the batch and the desired concentration of the disinfectant and/or bleaching agent (ii) on the foam and can be readily ascertained by a few simple experiments by the person skilled in the art.

The disinfectant and/or bleaching agents (ii), which can form a complex with (i), used are hydrogen peroxide and silver(I) ions, copper(II) ions and zinc(II) ions which can form a stable complex with the polymers of heterocyclic N-vinyl monomers (i). Preference is given to using hydrogen peroxide. This is usually used in the form of aqueous solutions, preferably in the form of 3 to 70% strength by weight, in particular 30 to 60% strength by weight, solutions. The silver, copper and zinc ions are used as aqueous solutions of mineral salts, such as, for example, silver(I) nitrate, silver(I) sulfate, copper(II) sulfate, copper(II) nitrate, zinc(II) nitrate and zinc(II) sulfate. Usually, the concentration of the metal salt solution here is adjusted to 10-10 000 ppm of metal ions.

The polyurethane foams according to the invention preferably have a content of (i) of from 0.1 to 100% by weight, and a content of (ii) of 0.1-50% by weight, particularly preferably 1-40% by weight and in particular 5 to 30% by weight, in each case based on the weight of the foam.

The foams produced by the method according to the invention which comprise a complex of (i) with (ii) are suitable for a large number of applications in the field of disinfection, hygiene or for bleaching.

The foams according to the invention can, for example, be used for producing cleaning sponges with a disinfectant and/or bleaching effect in the domestic sector. Thus, for example, sponges can be used for cleaning sanitary installations, such as toilets, washbasins, bath tubs and shower cubicles or sinks, where, as a result of delivering the disinfectant and/or bleaching agent (ii), the germ count of said surfaces can be reduced. Such sponges can likewise be used for the surface disinfection of operating and examination tables and couches in medical practices and hospitals.

A further application of the foams according to the invention is the use as insert, in particular in the area of adult incontinence, for diapers, in female hygiene and as sterile burn and wound coverings. Use of the disinfectant foams is also possible for cleaning wounds, for example for removing dirt from grazes. The field of use also includes the disinfection of shoes, head or neck cushions and mattresses.

Use in tamponades, pads or swabs is possible in the treatment of acne, care in the oral sector due to their astringent and disinfecting effect, for example after extractions. A further field of use is use as vaginal tamponades.

In addition, use in pet hygiene is advantageous. Thus, for example, dog and/or cat baskets can be made germicidal using the foams according to the invention. Similarly, use of the modified foams as starting material for so-called cow or horse mattresses for laying in stalls offers advantages compared to conventional mattresses with regard to improved stall hygiene and reduced germ count.

The foams are likewise suitable for the filtration of drinks such as mineral waters, fruit juices, wine or beer.

They are also suitable for use in filter systems for portion-wise water sterilization in cases of catastrophe and emergency situations.

Furthermore, the modified foams can be used as filters in the dyeing and textile industry for decoloring process waters and wastewaters.

The complexes according to the invention can also be used in air filters for air conditioning systems and in clean-room technology, in particular for disinfecting air in hospitals and care homes.

Furthermore, the foams according to the invention can be used for surface bleaching, for example in hair cosmetics for hair bleaching or oxidation of dyes in hair coloring. They can likewise be used as foams for removing stains from textiles and leather, for example for the surface removal of stains from, for example, fruit, tea, red wine and blood from items of clothing and carpets. In a particular embodiment of the invention, the modified foams can additionally comprise an enzyme which accelerates the degradation of bodily fluids such as blood.

The polyurethane foams produced by the method according to the invention preferably have a density of from 10 to 800 kg/m³, particularly preferably from 20 to 700 kg/m³ and in particular from 20 to 50 kg/m³.

The production of polyurethane foams by reacting isocyanates, for example polyisocyanates, with compounds having at least two hydrogen atoms which are reactive with isocyanates is generally known.

To produce the polyurethanes according to the invention, the isocyanates can be reacted with the compounds having at least two active hydrogen atoms in the presence of blowing agents and, if appropriate, catalysts and/or auxiliaries and/or additives. Here, the compounds having at least two hydrogen atoms reactive with isocyanate groups, and the specified blowing agents, catalysts and auxiliaries and/or additives are often combined before the reaction to give a so-called polyol component, and this is reacted with the isocyanate component.

The following is to be stated specifically with regard to the feed products used for carrying out the method according to the invention:

isocyanates, preferably polyisocyanates, particularly preferably diisocyanates, which can be used are the customary and known (cyclo)aliphatic and aromatic polyisocyanates. Examples of aromatic polyisocyanates are 2,4- and 2,6-tolylene diisocyanate (TDI), 4,4′-, 2,4′- and 2,2′-diphenylmethane diisocyanate (MDI), polyphenylene polymethylene polyisocyanate (crude MDI), 1,5-naphthylene diisocyanate.

Examples of (cyclo)aliphatic di- or triisocyanates are tetramethylene diisocyanate-1,4, hexamethylene diisocyanate-1,6, isophorone diisocyanate, 2-methylpentamethylene diisocyanate, 2,2,4- or 2,4,4-trimethyl-1,6-hexamethylene diisocyanate, 2-butyl-2-ethyl-pentamethylene diisocyanate, 1,4-diisocyanatocyclohexane, 3-isocyanatomethyl-1-methyl-1-isocyanatocyclohexane, isocyanatopropyl cyclohexylisocyanate, xylylene diisocyanate, tetramethylxylylene diisocyanate, bis(4-isocyanatocyclohexyl)methane, lysine ester isocyanates, 1,3- or 1,4-bis(isocyanatomethyl)cyclohexane, 4-isocyanatomethyl-1,8-octamethylene diisocyanate, and mixtures thereof or the oligo- or polyisocyanates produced therefrom.

The oligo- or polyisocyanates can be produced from the specified di- or triisocyanates or mixtures thereof through linking by means of urethane, allophanate, urea, biuret, uretdione, amide, isocyanurate, carbodiimide, uretonimine, oxadiazinetrione or iminooxadiazinedione structures.

The specified isocyanates can also be modified, for example by incorporating carbodiimide groups. The polyisocyanates are often also used in the form of prepolymers. These are reaction products of said polyisocyanates with polyol components. In most cases, so-called isocyanate prepolymers are used, i.e. those reaction products of polyols and polyisocyanates which have free isocyanate groups at the chain end. The prepolymers and quasi prepolymers and their production are generally known and described widely. For the method according to the invention, prepolymers with an NCO content in the range from 25 to 3.5% by weight in particular are used.

In a preferred embodiment of the method according to the invention, the isocyanate components used are aromatic isocyanates, in particular TDI, MDI and/or crude MDI.

The compounds having at least two active hydrogen atoms used are preferably polyester alcohols and particularly preferably polyetherols with a functionality of from 2 to 8, in particular from 2 to 4, preferably 2 to 3, and a molecular weight in the range from 1000 to 8500 g/mol, preferably 1000 to 6000. The compounds having at least two active hydrogen atoms also include the chain extenders and crosslinkers, which may, if appropriate, be used together. The chain extenders and crosslinkers are preferably 2- and 3-functional alcohols with molecular weights of less than 1000 g/mol, in particular in the range from 60 to 150. Examples are ethylene glycol, propylene glycol, diethylene glycol, dipropylene glycol, polyethylene glycol with a molecular weight of less than 1000, polypropylene glycol with a molecular weight of less than 1000 and/or butanediol-1,4. Diamines can also be used as crosslinkers. If chain extenders and crosslinkers are used, their amount is preferably up to 5% by weight, based on the weight of the compounds having at least two active hydrogen atoms.

Catalysts which may be used for the production of the polyurethane foams according to the invention are the customary and known polyurethane formation catalysts, for example organic tin compounds, such as tin diacetate, tin dioctoate, dialkyltin dilaurate, and/or highly basic amines such as triethylamine, pentamethyidiethylenetriamine, tetramethyidiaminoethyl ether, 1,2-dimethylimidazole, dimethylcyclohexylamine, dimethylbenzylamine or preferably triethylenediamine. The catalysts are preferably used in an amount of from 0.01 to 5% by weight, preferably 0.05 to 2% by weight, based on the weight of the compounds having at least two active hydrogen atoms.

The blowing agent used for producing the polyurethane foams is preferably water, which reacts with the isocyanate groups to liberate carbon dioxide. Together with or instead of water it is also possible to use physically effective blowing agents, for example hydrocarbons, such as n-, iso- or cyclopentane, or halogenated hydrocarbons, such as tetrafluoroethane, pentafluoropropane, heptafluoropropane, pentafluorobutane, hexafluorobutane, dichloromonofluoroethane or acetals, such as, for example, methylal. The amount of the physical blowing agent here is preferably in the range between 1 to 15% by weight, in particular 1 to 10% by weight, the amount of water is preferably in the range between 0.5 to 10% by weight, in particular 1 to 5% by weight, in each case based on the weight of the compounds having at least two active hydrogen atoms.

Auxiliaries and/or additives which may be used are, for example, surface-active substances, foam stabilizers, cell regulators, external and internal release agents, fillers, pigments, hydrolysis protectants, and fungistatic and bacteriostatic substances.

The polyurethane foams are preferably produced by the one-shot method, for example using high-pressure or low-pressure technology. The foams can be produced in open or closed metallic molding tools or by the continuous application of the reaction mixture on conveyor belts to produce foam blocks.

It is particularly advantageous to work in accordance with the so-called two-component method, in which, as explained above, a polyol component and an isocyanate component are prepared and foamed together. The components are preferably mixed at a temperature in the range between 15 to 90° C., preferably 20 to 60° C. and particularly preferably 20 to 35° C. and introduced into the molding tool or onto the conveyor belt. The temperature in the molding tool is mostly in the range between 20 and 110° C., preferably 30 to 60° C. and particularly preferably 35 to 55° C.

The invention will be illustrated in more detail in the examples below.

### EXAMPLES

### Example 1

### Production of a Hydrophilic Polyurethane Flexible Foam

By intensively mixing 1000 g of polyol component with 305 g of isocyanate component using a stirrer at a speed of 1250 rpm and transferring the foaming mixture to a cube-shaped plastic vessel with a volume of 60 l, a polyurethane flexible foam was produced, the components being constructed as follows:

Polyol Component:

75 parts of a polyetherpolyol with the OH number 42 mg of KOH/g and an average functionality of 2.66 (Lupranol VP 9349® from BASF Aktiengesellschaft)

25 parts of a polyetherpolyol with the OH number 48 mg of KOH/g and an average functionality of 2.75 (Lupranol 2084® from BASF Aktiengesellschaft)

2.30 parts water

0.18 part Lupragen N 201® (BASF Aktiengesellschaft)

0.06 part Lupragen N 206® (BASF Aktiengesellschaft)

1.2 parts Dabco DC 198® (Air Products)

0.06 part Kosmos® 29

Isocyanate Component:

tolylene diisocyanate (Lupranat® T 80 A from BASF Aktiengesellschaft)

### Example 2

### Production of a Modified Hydrophilic Polyurethane Foam Comprising (i)

The procedure was as in Example 1, with the polyol component additionally comprising 10 parts by weight of a crosslinked, water-insoluble vinylpyrrolidone homopolymer with the name Luvicross® (BASF Aktiengesellschaft).

By intensely mixing 1000 g of polyol component with 278 g of isocyanate component using a stirrer at a speed of 1250 rpm and transferring the foaming mixture to a cube-shaped plastic vessel with a volume of 60 l, a polyurethane flexible foam was produced, the components being constructed as follows:

Polyol Component:

75 parts of a polyetherpolyol with the OH number 42 mg of KOH/g and an average functionality of 2.66 (Lupranol VP 9349® from BASF Aktiengesellschaft)

25 parts of a polyetherpolyol with the OH number 48 mg of KOH/g and an average functionality of 2.75 (Lupranol 2084® from BASF Aktiengesellschaft)

2.30 parts water

0.18 part Lupragen N 201® (BASF Aktiengesellschaft)

0.06 part Lupragen N 206® (BASF Aktiengesellschaft)

1.2 parts Dabco DC 198® (Air Products)

0.06 part Kosmos® 29

10 parts of a crosslinked and thus insoluble polyvinylpyrrolidone (Luvicross® from BASF Aktiengesellschaft)

Isocyanate Component:

Tolylene diisocyanate (Lupranat® T 80 A from BASF Aktiengesellschaft)

### Example 3

### Production of a Modified Hydrophilic Polyurethane Foam Comprising (i)

The procedure was as in Example 1, with the polyol component additionally comprising 1 part by weight of a crosslinked, water-insoluble copolymer of vinylimidazole and vinylpyrrolidone with the name Divergan® HM (BASF Aktiengesellschaft).

By intensively mixing 1000 g of polyol component with 278 g of isocyanate component using a stirrer at a speed of 1250 rpm and transferring the foaming mixture to a cube-shaped plastic vessel with a volume of 60 l, a polyurethane flexible foam was produced, the components being constructed as follows:

Polyol Component:

75 parts of a polyetherpolyol with the OH number 42 mg of KOH/g and an average functionality of 2.66 (Lupranol VP 9349® from BASF Aktiengesellschaft)

25 parts of a polyetherpolyol with the OH number 48 mg of KOH/g and an average functionality of 2.75 (Lupranol 2084® from BASF Aktiengesellschaft)

2.30 parts water

0.18 part Lupragen N 201® (BASF Aktiengesellschaft)

0.06 part Lupragen N 206® (BASF Aktiengesellschaft)

1.2 parts Dabco DC 198® (Air Products)

0.06 part Kosmos® 29

10 parts of a crosslinked and thus insoluble copolymer of vinylpyrrolidone and vinylimidazole (Divergan HM® from BASF Aktiengesellschaft)

Isocyanate Component:

Tolylene diisocyanate (Lupranat® T 80 A from BASF Aktiengesellschaft)

### Example 4

### Production of Hydrophilic Polyurethane Foams According to the Invention Comprising (ii), Complexed to (i)

The foams obtained in Examples 2 and 3 are impregnated with an aqueous 30% strength hydrogen peroxide solution at room temperature for 1 hour. For this, 30 g of hydrogen peroxide solution per g of foam are placed into a vessel and the foam is occasionally squeezed using a plunger. The foam is then dried for 4 h at 60° C. The fixed masses of hydrogen peroxide (H₂O₂) were then determined gravimetrically. They are given in Table 1.

For comparison, the reference sample from Example 1 was treated in the same way without the addition of (i).

Table 1 shows the fixed masses of hydrogen peroxide on the various foams

TABLE 1
fixed masses of hydrogen peroxide on the various foams

| | | | |
|---|---|---|---|
| Foam of | Example 2 | Example 3 | Example 1 |

| | | |
|---|---|---|
| Polymer (i) | Luvicross | Divergan HM |

| | | | | | | |
|---|---|---|---|---|---|---|
| Mass of foam | 10.23 | g | 10.23 | g | 9.86 | g |
| Mass of foam after | 28.58 | g | 29.31 | g | 25.74 | g |
| impregnation | | | | | | |
| Mass of foam after | 13.96 | g | 13.27 | g | 10.25 | g |
| drying | | | | | | |
| Mass of fixed H₂O₂ | 3.73 | g | 3.04 | g | 0.39 | g |
| Mass of fixed H₂O₂ | 0.36 | g | 0.30 | g | 0.04 | g |
| per 1 g of foam | | | | | | |

### Example 5

### Testing the Release of the Complexed Hydrogen Peroxide in an Aqueous Environment

To determine the amount of hydrogen peroxide which can be washed out, a cascade of 5 rinsing vessels each containing 400 ml of water is used. The foam is placed successively into the vessels for 10 s in each case and squeezed a number of times during this period. 25 ml or 50 ml of the wash solution are then pipetted off and admixed with 5 ml of concentrated sulfuric acid, and the content of hydrogen peroxide is determined titrimetrically using potassium permanganate measuring solution. 2 measuring solutions with the concentrations c(KMn₄)=0.01 mol/L and c(KMn₄)=2 mmol/L are used. The titer of the measuring solutions is determined analogously to the H₂O₂ determination using sodium oxalate. The mass concentration of hydrogen peroxide was calculated according to the following formula.

$$β ( {H}_{2} {O}_{2} ) = \frac{5 * 1000 mg}{2 * 1 g} * \frac{V ( {KMnO}_{4} ) * c ( {KMnO}_{4} ) * t ( {KMnO}_{4} ) * M ( {H}_{2} {O}_{2} )}{V ( sample )}$$

β(H₂O₂): mass concentration of H₂O₂ [mg/l]

V(KMnO₄): consumption of potassium permanganate measuring solution [l]

c(KMnO₄): concentration of the potassium permanganate measuring solution [mol/l]

t(KMnO₄): titer of the potassium permanganate measuring solution

M(H₂O₂): molar mass of hydrogen peroxide [g/mol]

V(sample): partial volume of the washing solution

Table 2 shows the released amounts of hydrogen peroxide from the foam from Example 2.

TABLE 2
Released amount of hydrogen peroxide from the foam from Example 2 in an
aqueous environment

| Rinsing vessel | V(sample) | V(KMnO₄) | c(KMnO₄) | t(KMnO₄) | m(H₂O₂) | β(H₂O₂) |
|---|---|---|---|---|---|---|
| 1 | 25.00 ml | 13.40 mL | 0.010 mol/l | 1.021 | 11.634 mg | |
| | 25.00 ml | 13.40 mL | 0.010 mol/l | 1.021 | 11.634 mg | 465.4 mg/l |
| 2 | 25.00 ml | 4.30 mL | 0.002 mol/l | 0.988 | 0.723 mg | |
| | 25.00 ml | 4.30 mL | 0.002 mol/l | 0.988 | 0.723 mg | 28.9 mg/l |
| 3 | 25.00 ml | 0.60 mL | 0.002 mol/l | 0.988 | 0.101 mg | |
| | 25.00 ml | 0.60 mL | 0.002 mol/l | 0.988 | 0.101 mg | 4.0 mg/l |

Table 3 shows the released amounts of hydrogen peroxide from the foam from Example 3.

TABLE 3
Released amount of hydrogen peroxide from the foam from Example 3 in an
aqueous environment

| Rinsing vessel | V(sample) | V(KMnO₄) | c(KMnO₄) | t(KMnO₄) | m(H₂O₂) | β(H₂O₂) |
|---|---|---|---|---|---|---|
| 1 | 25.00 ml | 10.25 ml | 0.010 mol/l | 1.021 | 8.899 mg | |
| | 25.00 ml | 10.30 ml | 0.010 mol/l | 1.021 | 8.943 mg | 356.8 mg/l |
| 2 | 25.00 ml | 5.10 ml | 0.002 mol/l | 0.988 | 0.857 mg | |
| | 25.00 ml | 5.00 ml | 0.002 mol/l | 0.988 | 0.840 mg | 33.9 mg/l |
| 3 | 25.00 ml | 0.70 ml | 0.002 mol/l | 0.988 | 0.118 mg | |
| | 25.00 ml | 0.70 ml | 0.002 mol/l | 0.988 | 0.118 mg | 4.7 mg/l |
| 4 | 50.00 ml | 0.50 ml | 0.002 mol/l | 0.988 | 0.084 mg | |
| | 50.00 ml | 0.50 ml | 0.002 mol/l | 0.988 | 0.084 mg | 1.7 mg/l |

Table 4 shows the released absolute amounts of hydrogen peroxide calculated therefrom in mg based on 1 g of foam.

TABLE 4
Released absolute amounts of hydrogen peroxide
m(H₂O₂) in mg based on 1 g of foam.

| Foam from | |
|---|---|
| Example 2 | Example 3 |

| Rinising | β(H₂O₂) | m(H₂O₂) | β(H₂O₂) | m(H₂O₂) |
|---|---|---|---|---|
| vessel no. | [mg/l] | [mg] | [mg/l] | [mg] |
| 1 | 465 | 186.000 | 357 | 142.800 |
| 2 | 29 | 11.600 | 34 | 13.600 |
| 3 | 4 | 1.600 | 5 | 2.000 |
| 4 | 1 | 0.400 | 2 | 0.800 |
| 5 | <1 | 0.000 | <1 | 0.000 |

1. A polyurethane foam comprising polymers of heterocyclic N-vinyl monomers (i) and a disinfectant and/or bleaching agent (ii).

2. The polyurethane foam according to claim 1, wherein the polymers (i) are chosen from the group comprising vinylpyrrolidone homopolymers, polyvinylpyrrolidone, modified polyvinylpyrrolidine, copolymers of vinylpyrrolidone with vinylimidazole, copolymers of vinylpyrrolidone with vinyl acetate, copolymers of vinylpyrrolidone with vinylformamide.

3. The polyurethane foam according to claim 1, wherein the polymers (i) are crosslinked polypyrrolidone and/or crosslinked copolymer of vinylpyrrolidone and vinylimidazole.

4. The polyurethane foam according to claim 1, wherein the polymers of heterocyclic N-vinyl monomers (i) are used in an amount of from 0.1 to 100% by weight, based on the weight of the foam.

5. The polyurethane foam according to claim 1, wherein the disinfectant and/or bleaching agents (ii) are chosen from the group hydrogen peroxide and silver(I) ions, copper(II) ions and zinc(II) ions.

6. The polyurethane foam according to claim 1, wherein the disinfectant and/or bleaching agent (ii) is hydrogen peroxide.

7. The polyurethane foam according to claim 1, wherein the disinfectant and/or bleaching agents (ii) are used in an amount of 0.1-50% by weight, based on the weight of the foam.

8. The polyurethane foam according to claim 1, wherein the disinfectant and/or bleaching agents (ii) are used in an amount of from 1 to 40% by weight, based on the weight of the foam.

9. The polyurethane foam according to claim 1, wherein the disinfectant and/or bleaching agents (ii) are used in an amount of from 10 to 30% by weight, based on the weight of the foam.

10. A method of producing polyurethane foams comprising crosslinked polymers of heterocyclic N-vinyl monomers (i) and a disinfectant and/or bleaching agent (ii), comprising the steps
a) reaction of polyisocyanates with compounds having at least two hydrogen atoms reactive with isocyanate groups in the presence of polymers of heterocyclic N-vinyl monomers (i),
b) impregnation of the foam with a disinfectant bleaching agent (ii).

11. The use of polyurethane foams according to claim 1 in the field of disinfection, hygiene and bleaching.
